(19) United States
(12) Patent Application Publication
(10) Pub. No.: US 2007/0188383 A1
(43) Pub. Date: Aug. 16, 2007

(54) Antenna and portable radio communication apparatus

(75) Inventors: Kengo Onaka, Kanagawa-ken (JP); Jin Sato, Kanagawa-ken (JP); Takashi Ishihara, Tokyo-to (JP); Shoji Nagumo, Kanagawa-ken (JP); Kazunari Kawahata, Tokyo-to (JP)

Correspondence Address: MURATA MANUFACTURING COMPANY, LTD.;C/O KEATING & BENNETT, LLP, 8180 GREENSBORO DRIVE, SUITE 850, MCLEAN, VA, 22102, US

(73) Assignee: MURATA MANUFACTURING CO., LTD., Nagaokakyo-shi, Kyoto-fu (JP)

(21) Appl. No.: 10/598,893

(22) PCT Filed: Jan. 27, 2005
(86) PCT No.: PCT/JP05/01075

§ 371 Date: Sep. 14, 2006

(30) Foreign Application Priority Data
Apr. 27, 2004 (JP) 2004-132033

(51) Int. Cl. H01Q 1/38

(52) U.S. Cl. 343/700 MS; 343/702

(57) ABSTRACT

In an antenna, a feeding radiation element and a first non-feeding radiation element that are loaded with dielectric substances are provided on a ground electrode, and a second non-feeding radiation element is disposed such that substantially the entire second non-feeding radiation element projects outside from a desired side of the ground electrode. More specifically, each of the three electrode elements is loaded with a dielectric substance, and a radiation electrode of the second non-feeding radiation element is electrically connected at a substantially central location of the desired side of the ground electrode via a connection wire.

### BACKGROUND OF THE INVENTION

1. Field of the Invention

The present invention relates to antennas and portable radio communication apparatuses, and more particularly, to an antenna that performs a multiple resonance and a portable radio communication apparatus including the antenna.

2. Description of the Related Art

Antennas and portable radio communication apparatuses of this type are disclosed, for example, in Japanese Unexamined Patent Application Publication No. 2003-283238 (Patent Document 1), Japanese Unexamined Patent Application Publication No. 2003-283225 (Patent Document 2), Japanese Unexamined Patent Application Publication No. 2003-8326 (Patent Document 3), and Japanese Unexamined Patent Application Publication No. 2003-347835 (Patent Document 4).

In Patent Document 1, as shown in FIG. 15, a technology for increasing the bandwidth of a single-resonance ¼ λmicrostrip antenna 100 that is a so-called sheet metal inverted-F antenna is disclosed. More specifically, the bandwidth is increased by providing an antenna element 105 and installing a linear ground wire 101a or a wound ground wire 101b in the vicinity of a corner of a ground plate (ground electrode) 102. In addition, a narrower short-circuit wire 104 is provided independently of a feeding wire 103. The short-circuit wire 104 defines a short-circuit stub which functions as a matching circuit for matching with an input impedance for feeding.

In addition, in Patent Document 2, as shown in FIG. 16, a technology for causing a first antenna element 202 and a second antenna element 203 to produce a double resonance by installing the first antenna element 202 and the second antenna element 203 in a portion near an end 201 in a longitudinal direction (one of two shorter sides at both ends) of a casing 204 of a cellular phone unit 200 and by supplying power to the first antenna element 202 and supplying no power to the second antenna element 203 is disclosed.

In addition, in Patent Document 3, as shown in FIG. 17, a surface-mount antenna main unit 300 in which a feeding radiation electrode 301, a first non-feeding radiation electrode 302, and a second non-feeding radiation electrode 303 produce a multiple resonance by disposing the feeding radiation electrode 301, the first non-feeding radiation electrode 302, and the second non-feeding radiation electrode 303 on a dielectric base member 304 is disclosed. In the surface-mount antenna main unit 300, electric field coupling between a feeding radiation electrode and a non-feeding radiation electrode is achieved by enabling the dielectric base member 304 to function as an electric capacitor connected to the non-feeding radiation electrodes 302 and 303. Accordingly, the surface-mount antenna main unit 300 achieves a multiple resonance.

In addition, in Patent Document 4, as shown in FIG. 18, a technology for improving antenna gain while maintaining the sharpness of the directivity of the entire antenna by forming a ground opening 402 in a ground electrode 401 on which a surface-mount antenna main unit 400 is provided is disclosed. Since the ground opening 402 is formed by drilling a through hole in the ground electrode 401, the ground opening 402 is surrounded by a conductor of the ground electrode 401. The entire antenna including the surface-mount antenna main unit 400 is a multiple-resonance antenna in which a radiation electrode 403 and a radiation electrode 404 are provided on a surface of a dielectric base member 402.

However, the foregoing portable radio communication apparatuses have the following problems.

In the technologies described in Patent Documents 1 and 2, it is difficult to achieve an excellent multiple resonance including two or more resonances in fundamental waves and harmonic waves.

That is, since the antenna elements 105, 202, and 203, and the ground wires 101a and 101b are not loaded with a dielectric substance, it is difficult to set electromagnetic coupling between these components in a desired manner. In addition, since a location of the ground plate 102 to which the ground wires 101a and 101b are connected is restricted to the vicinity of a corner of the ground plate 102, sufficient electromagnetic coupling is not achieved between the ground wires 101a and 101b and the ground plate 102. Thus, for example, when a resonance is set so as to match one of a fundamental wave and a harmonic wave, it is often difficult to achieve matching of the resonance with the other one of the fundamental wave and the harmonic wave.

In addition, in particular, the ground wire 101a suggested in Patent Document 1 extends along a line from a longer side of the ground plate 102 to the outside. Thus, when an antenna including the ground wire 101a is incorporated into, for example, a cellular phone unit, the ground wire 101a protrudes in an elongated shape in a horizontal direction from the body of the cellular phone unit. Thus, the protruding ground wire 101a greatly disturbs users. In addition, handling of the cellular phone unit is complicated. When the wound ground wire 101b is provided, the ground wire 101b is less disturbing than the linear ground wire 101a. However, since the ground wire 101b greatly expands outside the ground plate 102, this arrangement does not enable a reduction in the overall size of the cellular phone unit including the ground wire 101b.

In addition, it is difficult to achieve an increase in bandwidth (to achieve a wider bandwidth in which transmission and reception can be performed) while reducing the thickness of the entire antenna. That is, as shown in FIG. 15, since coupling saturation caused by an electric field E that leaks out toward the ground wire 101b must be prevented, a minimum distance must be provided between the ground plate 102 and the ground wire 101b. Thus, due to this minimum distance, a reduction in thickness and miniaturization are prevented. In addition, since a minimum height (the height from the ground plate 102 to the antenna element 105) is required for an inverted-F structure in order to achieve an increase in bandwidth, such a height prevents the reduction in thickness.

In addition, when the above-mentioned antenna is used for, for example, a cellular phone unit, a problem occurs in which the antenna characteristics are adversely affected when a user's head is moved closer to the antenna for conversation. That is, since the above-mentioned antenna is not loaded with a dielectric substance, a large electric field leaks out toward the head. Thus, when the head, which has a high dielectric constant, approaches the antenna, a function of the antenna to transmit and receive radio waves for communication may be inhibited.

In addition, since the ground wires 101a and 101b and the antenna elements 202 and 203 are connected to an end on one side of the ground plate 102, deviation occurs in the current distribution of the ground plate 102 in a direction along the one side of the ground plate 102, and an induced current is generated. Due to a voltage drop of the induced current, the electric field that leaks out toward the head is increased. Thus, when a user's head is moved closer to the antenna, the function of the antenna to transmit and receive radio waves for communication is inhibited.

In addition, in particular, in the technology described in Patent Document 2, when the antenna elements 202 and 203 expand outside a ground plate (not shown in FIG. 16), an electrostatic shielding effect of the ground plate does not reach the antenna elements 202 and 203. In particular, when the antenna elements 202 and 203 are disposed in a portion near the upper end of a cellular phone unit, these elements are closest to the head of a user when the user uses the cellular phone unit. Thus, when the head, which has a high dielectric constant, approaches the antenna, the operation characteristics of the entire antenna are adversely affected by the head. In addition, when the antenna elements 202 and 203 extend on the ground plate, an advantage of a wider bandwidth can be achieved due to a multiple resonance, as compared to a single-resonance antenna. However, since the Q-value of each of two resonances defining the multiple resonance is high, the increase in bandwidth is limited.

In addition, in the technologies described in Patent Documents 1 and 2, the elongated ground wire 101a protruding at the corner of the ground plate 102 and the antenna element 105 disposed a predetermined height from the ground plate 102 are obstructive to the attachment of a CCD image pickup element, a flash element, a liquid crystal display element (not shown), or other components. Alternatively, the elongated ground wire 101a protruding at the corner of the ground plate 102 and the antenna element 105 disposed at a predetermined height from the ground plate 102 limit the design of the body of a radio communication apparatus, such as a cellular phone unit. This inhibits a reduction in the thickness and miniaturization of the entire radio communication apparatus.

In contrast, in the technology described in Patent Document 3, although a reduction in the thickness and miniaturization of the entire antenna and an increase in bandwidth are achieved, a further increase in bandwidth is desired. Thus, there is a need to satisfy this need for a further increase in bandwidth.

In addition, in the technology described in Patent Document 4, due to the ground opening 402, the antenna gain can be improved while the sharpness of the directivity of the entire antenna is maintained. However, since the ground opening 402 is merely a space (opening) of limited size, such as, at most, about several millimeters, surrounded by the ground electrode 401, the ground opening 402 is not significantly large with respect to a wavelength, depending on the frequency band to be used. Thus, the desired increase in bandwidth cannot be achieved.

### SUMMARY OF THE INVENTION

To overcome the problems described above, preferred embodiments of the present invention provide an antenna that achieves a reduction in the thickness and miniaturization of the overall size and that achieves a further increase in bandwidth, and a portable radio communication apparatus including such an antenna.

An antenna according to a preferred embodiment of the present invention includes a substrate including a ground electrode having a substantially rectangular shape, a feeding radiation element including a feeding element and a radiation electrode inside or outside a dielectric substance, a first non-feeding radiation element electrically connected to the ground electrode and including a radiation electrode inside or outside a dielectric substance, and a second non-feeding radiation element electrically connected to the ground electrode and including a radiation electrode inside or outside a dielectric substance. The feeding radiation element is arranged on the ground electrode such that a surface of the radiation electrode of the feeding radiation element is substantially parallel to a surface of the ground electrode, and such that the feeding radiation element is disposed in the vicinity of a desired side of the four peripheral sides of the ground electrode. The first non-feeding radiation element is arranged on the ground electrode such that a surface of the radiation electrode is substantially parallel to the surface of the ground electrode and such that the first non-feeding radiation element is disposed next to the feeding radiation element so as to be in the vicinity of the desired side. The second non-feeding radiation element is arranged such that the second non-feeding radiation element is adjacent to both the feeding radiation element and the first non-feeding radiation element and such that at least a portion of the second non-feeding radiation element projects outside the ground electrode from the desired side.

With this arrangement, the ground electrode, the feeding radiation element, the first non-feeding radiation element, and the second non-feeding radiation element produce a triple resonance with outstanding matching over a wide bandwidth.

In addition, since the radiation electrode of each of the feeding radiation element and the first and second non-feeding radiation elements is loaded with a dielectric substance, the amount of electric field coupling between the three electrodes can be set with high flexibility.

In addition, the feeding radiation element and the first non-feeding radiation element of the three electrode elements are disposed on the ground electrode, and the second non-feeding radiation element is disposed outside the ground electrode. Thus, the three electrode elements produce a multiple resonance defined by three types of resonances that are different from each other. Thus, for example, a multiple resonance with outstanding matching is achieved over a wide band including, for example, a fundamental wave, a first harmonic wave, and a second harmonic wave. Thus, a further increase in bandwidth is achieved.

In addition, the second non-feeding radiation element loaded with a dielectric substance is disposed outside the ground electrode, instead of being disposed on the ground electrode. Thus, a ground wire and an antenna element disposed away from a ground plate with a desired distance (thickness) therebetween that are necessary for causing an inverted-F antenna to produce a multiple resonance are not required, and a reduction in the thickness and miniaturization are achieved. In addition, since a ground wire is not required, there are no restrictions on the shape of a corner portion of the ground electrode (ground plate) due to such a ground wire.

The second non-feeding radiation element may be electrically connected at substantially a central location of the desired side of the ground electrode.

With this arrangement, the second non-feeding radiation element is electrically connected at a substantially central location of one side of the ground electrode. Thus, induced currents flow symmetrically with respect to the substantially central location of the one side and have opposite phases, and the induced currents cancel each other. Thus, for example, leakage of an electric field from an antenna to a head of a user when the user's head is moved closer to the antenna is prevented and minimized.

A resonance due to the second non-feeding radiation element may be assigned to a higher frequency side or a lower frequency side of a multiple resonance due to the feeding radiation element and the first non-feeding radiation element to produce a triple resonance.

With this arrangement, a further increase in bandwidth and in efficiency is achieved as compared to an antenna having two resonances.

A resonance due to the second non-feeding radiation element may be assigned to a higher frequency side or a lower frequency side of a multiple resonance due to a harmonic wave of the feeding radiation element and a harmonic wave of the first non-feeding radiation element to produce a triple resonance.

With this arrangement, a further increase in bandwidth and in efficiency is achieved as compared to an antenna having two resonances.

The ground electrode is preferably defined by a conductor pattern that is provided on the substrate and that has a substantially rectangular shape when viewed in plan. The feeding radiation element and the first non-feeding radiation element are provided close to one of two shorter sides at ends in a longitudinal direction of the ground electrode. The second non-feeding radiation element is arranged such that almost the entire second non-feeding radiation element projects outside the ground electrode from the side.

With this arrangement, the antenna is suitable for being incorporated into, for example, a cellular phone unit having an elongated body shape.

The radiation electrode of each of the feeding radiation element, the first non-feeding radiation element, and the second non-feeding radiation element are preferably provided on a dielectric base member or within the dielectric base member.

With this arrangement, an antenna element in which the feeding radiation element, the first non-feeding radiation element, and the second non-feeding radiation element are integrated with a dielectric base member is produced. Such an integrated antenna element is easily provided on the ground electrode.

The feeding radiation element, the first non-feeding radiation element, and the second non-feeding radiation element are preferably formed by insert molding or outsert molding using, as the dielectric base member, a dielectric material and a thermoplastic resin.

Alternatively, the radiation electrode of each of the feeding radiation element and the first non-feeding radiation element may be provided on a dielectric base member. The radiation electrode of the second non-feeding radiation element is preferably provided on a dielectric base member that is different from the dielectric base member on which the radiation electrode of each of the feeding radiation element and the first non-feeding radiation element is provided.

With this arrangement, the feeding radiation element and the first non-feeding radiation element are provided on the ground electrode such that the feeding radiation element and the first non-feeding radiation element are integrated with each other. Then, the second non-feeding radiation element can be added to the feeding radiation element and the first non-feeding radiation element that are integrated with each other.

The feeding radiation element and the first non-feeding radiation element are preferably formed by insert molding or outsert molding using, as the dielectric base member, a dielectric material and a thermoplastic resin. The second non-feeding radiation element is preferably formed by insert molding or outsert molding using, as the different dielectric base member, a dielectric material and a thermoplastic resin.

The dielectric base member and the different dielectric base member have a fitting structure in which a fitting arrangement is uniquely defined by fitting the dielectric base member to the different dielectric base member.

At least one of a chip capacitor and a chip inductor is preferably installed in the middle of at least one of an electrical connection path between the radiation electrode and the ground electrode, an electrical connection path between the radiation electrode of the first non-feeding radiation element and the ground electrode, and an electrical connection path between the radiation electrode of the second non-feeding radiation element and the ground electrode.

A portable radio communication apparatus according to another preferred embodiment of the present invention includes any one of the above-mentioned antennas.

As described above, according to preferred embodiments of the present invention, each of the feeding radiation element, the first non-feeding radiation element, and the second non-feeding radiation element is loaded with a dielectric substance and disposed on the ground electrode, and the second non-feeding radiation element projects outside from one side of the ground electrode. Thus, an antenna having a reduced thickness and a miniaturized overall size and that achieves a further increase in bandwidth is provided.

In addition, according to other preferred embodiments of the present invention, a portable radio communication apparatus that achieves outstanding communication in a wide band and that achieves a reduced thickness and a miniaturized overall size is provided.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a plan view of an antenna according to a first preferred embodiment of the present invention.

FIG. 2 is a side view of the antenna according to the first preferred embodiment of the present invention.

FIG. 3 is a perspective view of the antenna according to the first preferred embodiment of the present invention.

FIG. 4 is a perspective view of a second non-feeding radiation element 5.

FIG. 5 is a plan view of the second non-feeding radiation element 5 when the second non-feeding radiation element 5 is expanded based on a peripheral surface of the second non-feeding radiation element 5.

FIG. 6 is a graph showing experiment results of the resonance characteristics of the antenna according to the first preferred embodiment of the present invention.

FIG. 7 is a graph showing each resonant state of the antenna.

FIG. 8 is a graph showing a magnified fundamental-wave portion.

FIG. 9 is a graph showing a magnified harmonic-wave portion.

FIG. 10 is a perspective view of an antenna according to a second preferred embodiment of the present invention.

FIG. 11 is an equivalent circuit diagram showing the antenna according to the second preferred embodiment of the present invention.

FIG. 12 is a perspective view of an antenna according to a third preferred embodiment of the present invention.

FIG. 13 is a perspective view showing a fitting structure in an antenna according to a fourth preferred embodiment of the present invention.

FIG. 14 is a perspective view showing another example of the fitting structure in the antenna according to the fourth preferred embodiment of the present invention.

FIG. 15 is an illustration showing an example of a schematic structure of a known inverted-F antenna.

FIG. 16 is an illustration showing an example of a known cellular phone unit including a first antenna element and a second antenna element at an end in a longitudinal direction.

FIG. 17 is an illustration showing a triple-resonance surface-mount antenna main unit.

FIG. 18 is an illustration showing an antenna device in which a ground opening is formed in a ground electrode on which a surface-mount antenna main unit is provided.

### DETAILED DESCRIPTION OF PREFERRED EMBODIMENTS

Preferred embodiments of the present invention will be described with reference to the drawings.

### Preferred Embodiment 1

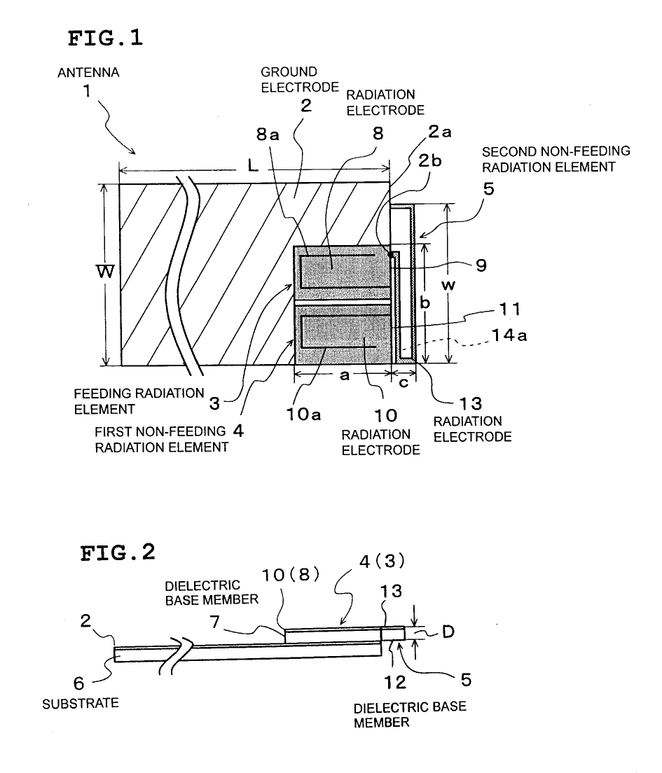

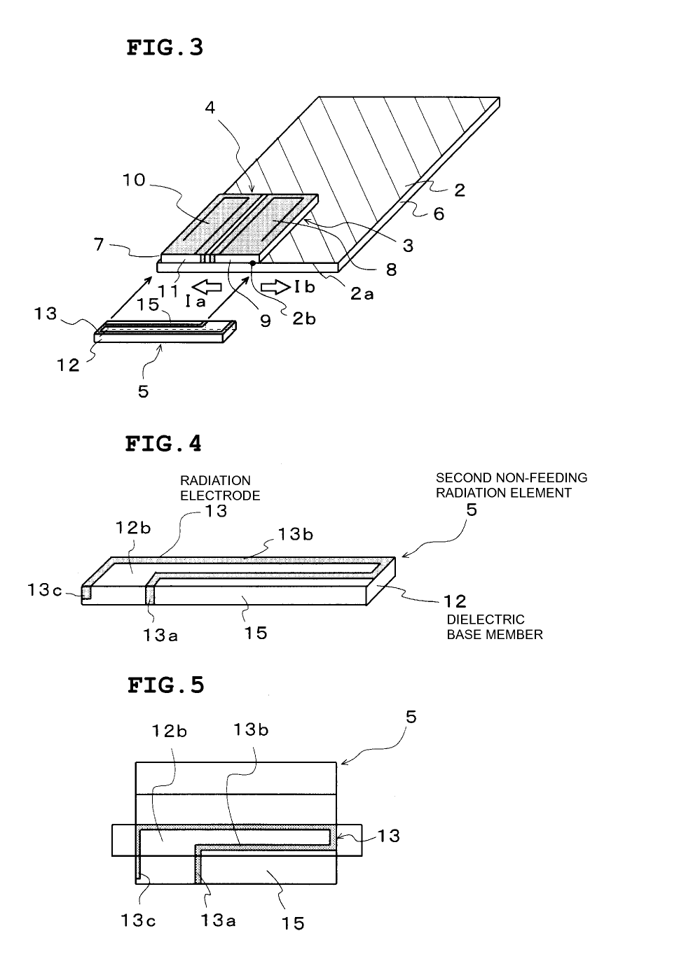

FIG. 1 is a plan view showing an antenna according to a first preferred embodiment of the present invention, FIG. 2 is a side view of the antenna according to the first preferred embodiment, and FIG. 3 is a perspective view of the antenna according to the first preferred embodiment of the present invention.

As shown in FIG. 1, an antenna 1 according to this preferred embodiment preferably includes a ground electrode 2, a feeding radiation element 3, a first non-feeding radiation element 4, and a second non-feeding radiation element 5.

The ground electrode 2 includes a conductor having a substantially rectangular outer shape when viewed in plan and that is made of sheet metal or metallic foil and is installed on a substrate 6, as shown in FIG. 2. The ground electrode 2 functions as a so-called ground substrate.

As shown in FIG. 1, the feeding radiation element 3 is a substantially flat surface mount element preferably having a substantially rectangular parallelepiped shape. The feeding radiation element 3 is disposed on the ground electrode 2 such that one side (referred to as a connection side 9) is disposed substantially parallel to and in the vicinity of a desired side 2a of the ground electrode 2.

As shown in FIG. 3, the feeding radiation element 3 includes a dielectric base member 7 and a radiation electrode 8. The dielectric base member 7 is formed by, for example, injection molding of a dielectric material. The radiation electrode 8 is made of a conductor, such as sheet metal or metallic foil, provided on the surface of the dielectric base member 7. The radiation electrode 8 is an antenna pattern including about one turn and a slit 8a, as shown in FIG. 1. Thus, the surface of the radiation electrode 8 is substantially parallel to the surface of the ground electrode 2. The radiation electrode 8 is an electromagnetic wave radiation electrode that is loaded with a dielectric substance due to the dielectric base member 7. The radiation electrode 8 is connected to an external signal supply source, which is not shown, and actively radiates radio waves. That is, a feeding element, which is not shown, directly supplies power to the radiation electrode 8.

The first non-feeding radiation element 4 is a substantially flat element preferably having a substantially rectangular parallelepiped shape. The first non-feeding radiation element 4 is disposed next to the feeding radiation element 3 on the ground electrode 2 such that one side (referred to as a connection side 11) is disposed substantially parallel to and in the vicinity of the side 2a of the ground electrode 2.

As shown in FIGS. 2 and 3, the first non-feeding radiation element 4 includes the dielectric base member 7 and a radiation electrode 10. The dielectric base member 7 is shared with the feeding radiation element 3. Thus, similar to the radiation electrode 8, the surface of the radiation electrode 10 is substantially parallel to the surface of the ground electrode 2. The radiation electrode 10 is disposed adjacent to the radiation electrode 8 with a desired gap therebetween on the dielectric base member 7 and is connected to the ground electrode 2. Similar to the radiation electrode 8 of the feeding radiation element 3, the radiation electrode 10 is an antenna pattern including about one turn and a slit 10a, as shown in FIG. 1.

The second non-feeding radiation element 5 is a passive antenna element having a substantially flat and elongated shape. The second non-feeding radiation element 5 includes a dielectric base member 12 and a radiation electrode 13. The second non-feeding radiation element 5 is disposed adjacent to both the feeding radiation element 3 and the first non-feeding radiation element 4.

That is, as shown in FIG. 3, a connection side 15 of the second non-feeding radiation element 5 is attached in parallel to both the connection side 9 of the feeding radiation element 3 and the connection side 11 of the first non-feeding radiation element 4, and substantially the entire second non-feeding radiation element 5 projects outside the side 2a of the ground electrode 2.

FIG. 4 is a perspective view of the second non-feeding radiation element 5, and FIG. 5 is a plan view of the second non-feeding radiation element 5 when the second non-feeding radiation element 5 is expanded based on a circumferential surface of the second non-feeding radiation element 5.

As shown in FIG. 3, although the dielectric base member 12 is independent of the dielectric base member 7 and has a planar shape that is different from the dielectric base member 7, the dielectric base member 12 has the same thickness as the dielectric base member 7. The dielectric base member 12 is a rectangular parallelepiped and has longer sides in a direction of the side 2a of the ground electrode 2. The radiation electrode 13 is provided on the surface of the dielectric base member 12. Thus, similar to the radiation electrodes 8 and 10, the surface of the radiation electrode 13 is substantially parallel to the surface of the ground electrode 2.

More specifically, as shown in FIG. 4, an end 13a of the radiation electrode 13 is disposed on the connection side 15 of the dielectric base member 12. The radiation electrode 13 extends from the end 13a to a top surface 12b of the dielectric base member 12, and loops along a periphery of the top surface 12b. Then, the radiation electrode 13 returns to a left side in the drawing of the connection side 15. That is, as shown in FIG. 5, the radiation electrode 13 is arranged on the dielectric base member 12 such that both ends 13a and 13c of the radiation electrode 13 are disposed on the connection side 15 of the dielectric base member 12 and a loop portion 13b is disposed on the top surface 12b. In addition, as shown in FIG. 3, when the second non-feeding radiation element 5 is attached to the feeding radiation element 3 and the first non-feeding radiation element 4, the end 13a of the radiation electrode 13 is connected at a central location 2b of the side 2a of the ground electrode 2.

As described above, the feeding radiation element 3 and the first non-feeding radiation element 4 function as an integrated surface-mount element including the radiation electrode 8 and the radiation electrode 10 that are disposed adjacent to each other with a predetermined gap therebetween on the dielectric base member 7. In addition, the second non-feeding radiation element 5 is provided by disposing the radiation electrode 13 on the dielectric base member 12, which is independent of the dielectric base member 7. The second non-feeding radiation element 5 is an independent electrode element, separated from the feeding radiation element 3 and the first non-feeding radiation element 4. Thus, after the feeding radiation element 3 and the first non-feeding radiation element 4 are provided on the ground electrode 2, the second non-feeding radiation element 5 is provided by attaching the second non-feeding radiation element 5 to the connection sides 9 and 11. Accordingly, the surface of the radiation electrode 13 is substantially parallel to the surface of the ground electrode 2.

In addition, the feeding radiation element 3 and the first non-feeding radiation element 4 are preferably formed by disposing the radiation electrode 8 and the radiation electrode 10 in advance in desired locations within a die (not shown) for injection molding and by performing insert molding using, as a forming material of the dielectric base member 7, a dielectric material and a thermoplastic resin. Alternatively, the feeding radiation element 3 and the first non-feeding radiation element 4 may be formed by performing outsert molding.

In addition, similarly, the second non-feeding radiation element 5 is preferably formed by disposing the radiation electrode 13 in advance in a desired location within a die for injection molding and by performing insert molding using, as a forming material of the dielectric base member 12, a dielectric material and a thermoplastic resin. Alternatively, the second non-feeding radiation element 5 may be formed by performing outsert molding.

Operations and advantages of the antenna 1 according to this preferred embodiment are described below.

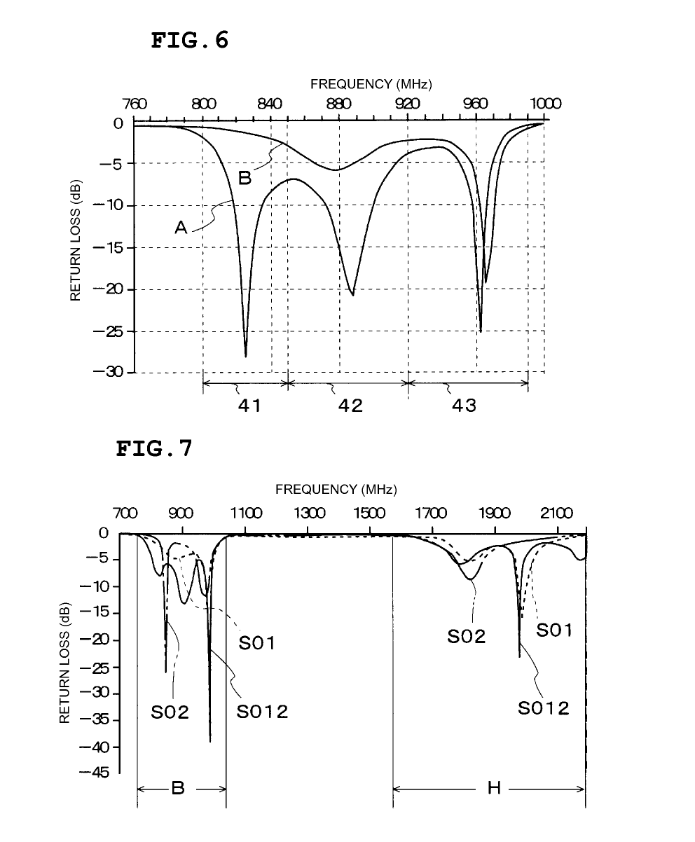

FIG. 6 is a graph showing experimental results when the resonance characteristics of a situation in which a second non-feeding radiation element is installed in the antenna according to this preferred embodiment and the resonance characteristics of a situation in which the second non-feeding radiation element is removed from the antenna are compared with each other.

When, in the antenna 1 shown in FIG. 1, a signal is supplied from an external signal supply source to the radiation electrode 8, the radiation electrode 8 actively radiates electromagnetic waves. Due to the electromagnetic waves, the radiation electrode 10 and the radiation electrode 13 passively resonate. Thus, the radiation electrode 8, the radiation electrode 10, and the radiation electrode 13 produce a triple resonance.

Here, the first non-feeding radiation element 4 is disposed on the ground electrode 2, and the second non-feeding radiation element 5 is disposed outside the ground electrode 2. In addition, the planar shape and the overall size are different between the first non-feeding radiation element 4 and the second non-feeding radiation element 5. Thus, the first non-feeding radiation element 4 and the second non-feeding radiation element 5 have resonant frequency bands that are different from each other. In addition, each of the radiation electrode 8, the radiation electrode 10, and the radiation electrode 13 is loaded with a dielectric substance. Thus, each of the radiation electrode 8, the radiation electrode 10, and the radiation electrode 13 resonates in a desired resonant frequency band.

In order to confirm the above-mentioned points, an experiment was performed. As shown by a curve A in FIG. 6, a triple resonance including clear peaks at resonant frequencies in three frequency bands 41, 42, and 43, which are different from each other, is achieved.

The experiment will now be described more specifically.

In this experiment, the resonance characteristics of a situation in which the second non-feeding radiation element 5 is installed in the antenna 1 and the resonance characteristics of a situation in which the second non-feeding radiation element 5 is removed from the antenna 1 are compared with each other.

More specifically, the dimensions of the ground electrode 2 are set such that the width W is about 40 mm and the length L is about 165 mm, for example. In addition, the dimensions of the dielectric base member 7 (see FIG. 2 or FIG. 3) (that is, the dimensions are substantially equal to the total of the dimensions of the feeding radiation element 3 and the dimensions of the first non-feeding radiation element 4) are set such that the width b is about 26 mm, the length a is about 23 mm, and the thickness D is about 3 mm, for example. In addition, the dimensions of the dielectric base member 12 (that is, the dimensions are substantially equal to the dimensions of the second non-feeding radiation element) are set such that the length w is about 32 mm, the width c is about 5 mm, and the thickness D is about 3 mm, for example. The dielectric base member 7 and the dielectric base member 12 are made of dielectric materials having a dielectric constant of about 6.4, for example.

Under such conditions, the resonant experiment is performed using the feeding radiation element 3, the first non-feeding radiation element 4, and the second non-feeding radiation element 5. As shown by the curve A in FIG. 6, a triple resonance with outstanding matching including three different resonant frequency bands, that is, a first resonant frequency band 41 in which the peak exists at about 825 MHz, a second resonant frequency band 42 in which the peak exists at about 890 MHz, and a third resonant frequency band 43 in which the peak exists at about 960 MHz is observed. That is, in the antenna 1 according to this preferred embodiment, in a fundamental wave, a multiple resonance with outstanding matching is achieved over a wide band from about 800 MHz to about 1000 MHz including the first resonant frequency band 41, the second resonant frequency band 42, and the third resonant frequency band 43.

In contrast, the experiment in which the feeding radiation element 3 and the first non-feeding radiation element 4 produce a resonance when the second non-feeding radiation element 5 is removed is performed. In this case, as shown by a curve B in FIG. 6, a resonance including the clear peak is generated in the third resonant frequency band 43. However, the resonance in the first resonant frequency band 41 is almost completely lost, and the sharpness of the resonance peak in the second resonant frequency band 42 is significantly reduced.

In accordance with the above-described experiment results, the occurrence of a multiple resonance with outstanding matching including clear peaks in the first resonance frequency bad 41, the second resonance frequency band 42, and the third resonant frequency band 43 is observed when the second non-feeding radiation element 5 of the antenna 1 is disposed outside the ground electrode 2.

Here, the fact that an antenna using the feeding radiation element 3, the first non-feeding radiation element 4, and the second non-feeding radiation element 5 is capable of producing a multiple resonance over a wide band is considered.

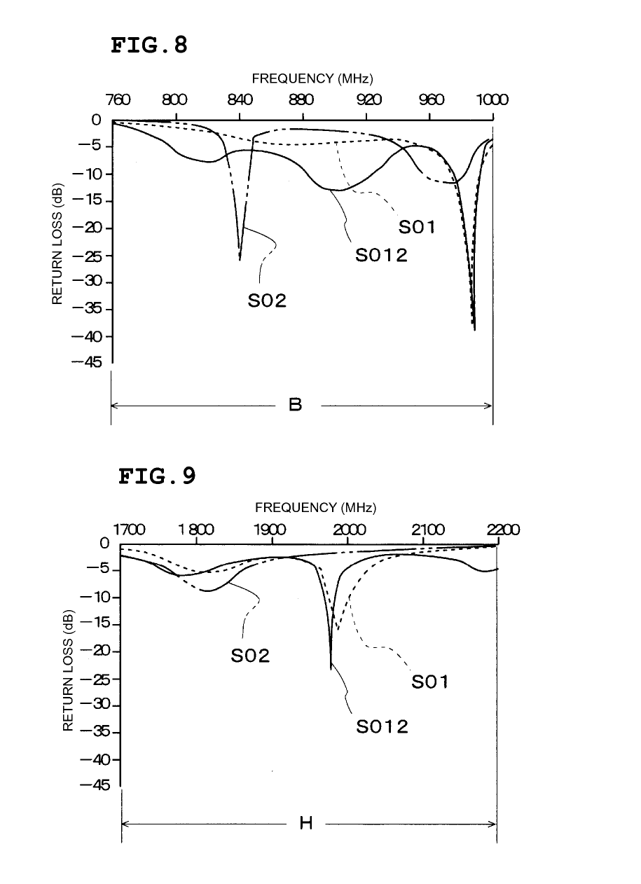

FIG. 7 is a graph showing each resonance in the antenna, FIG. 8 is a graph in which a fundamental-wave portion is magnified, and FIG. 9 is a graph in which a harmonic-wave portion is magnified.

As a first comparative example, an antenna main unit from which the first non-feeding radiation element 4 is removed, that is, the feeding radiation element 3 disposed on the ground electrode 2 produces a single resonance, and matching with the second non-feeding radiation element 5 disposed outside the ground electrode 2 is achieved. Accordingly, a multiple resonance in a fundamental wave is achieved. In this case, as shown by a curve S02 represented by a two-dot chain line in a fundamental-wave portion B in FIGS. 7 and 8, a multiple resonance is achieved in a fundamental wave. However, as shown by a curve S02 in a harmonic-wave portion H in FIGS. 8 and 9, a satisfactory resonance cannot be achieved in a harmonic wave.

As a second comparative example, the feeding radiation element 3 and the first non-feeding radiation element 4 that are disposed on the ground produce a multiple resonance (double resonance). In this case, as shown by a curve S01 represented by a dotted line in a fundamental-wave portion B and a harmonic-wave portion H in FIGS. 7 to 9, an outstanding resonance is achieved in a fundamental wave and a harmonic wave. However, since both the feeding radiation element 3 and the first non-feeding radiation element 4 are disposed on the ground electrode 2, the Q value of each of two resonances defining the double resonance is high. Thus, there is a limit to the increase in bandwidth for such a multiple resonance.

In accordance with the results of the first and second comparison examples, the fact that, for a single resonance, the use of the second non-feeding radiation element 5 disposed outside the ground electrode 2 increases the bandwidth although a problem occurs in a harmonic wave and that, for a multiple resonance caused by the feeding radiation element 3 and the first non-feeding radiation element 4 that are disposed on the ground electrode 2, an outstanding multiple resonance is achieved in a fundamental wave and a harmonic wave although a problem occurs in the width of the bandwidth is found. Thus, by combining the results of the first and second comparative examples and by providing an antenna including the feeding radiation element 3, the first non-feeding radiation element 4, and the second non-feeding radiation element 5, the advantages of the respective cases are added and the drawbacks are overcome.

Thus, the feeding radiation element 3 and the first non-feeding radiation element 4 are disposed on the ground electrode 2, the second non-feeding radiation element 5 is disposed outside the ground electrode 2, and the feeding radiation element 3, the first non-feeding radiation element 4, and the second non-feeding radiation element 5 produce a triple resonance. In this case, as shown by a curve S012 represented by a solid line in the fundamental-wave portion B and the harmonic-wave portion H in FIGS. 7 to 9, an outstanding triple resonance is achieved in a fundamental wave and a harmonic wave, and a wider bandwidth is also achieved. The antenna according to this preferred embodiment is prepared in view of such consideration. Thus, the use of the antenna according to this preferred embodiment achieves a communication apparatus supported by all the specifications of GSM 850/900/18001900/UMTS (a bandwidth between 824 MHz and 960 MHz and a bandwidth between 1710 MHz and 2170 MHz are used), CDMA 800 (a bandwidth between 832 MHz and 925 MHz is used), and PDC 800 (a bandwidth between 810 MHz and 960 MHz is used), as shown by the curve S012 in FIG. 7.

In the antenna 1 according to this preferred embodiment, as shown in FIGS. 2 and 3, each of the radiation electrode 8, the radiation electrode 10, and the radiation electrode 13 is loaded with a dielectric substance, and an outstanding multiple resonance is produced. Thus, even if the thickness of each of the feeding radiation element 3, the first non-feeding radiation element 4, and the second non-feeding radiation element 5 is not set to be equal to the thickness (the distance from a ground plate to an antenna plate that floats above the ground plate) in, for example, a generally known inverted-F antenna, an increase in bandwidth is achieved. As a result, a reduction in the thickness of the entire antenna 1 is achieved. For the antenna 1 according to this preferred embodiment, the thickness D of each of the feeding radiation element 3, the first non-feeding radiation element 4, and the second non-feeding radiation element 5 is about 3 mm, for example. Even if the thickness of the ground electrode 2 and the substrate 6 is added, a reduction in the thickness of the entire antenna 1 is achieved.

In addition, for example, for an inverted-F antenna that is not loaded with a dielectric substance, since a large electric field leaks out toward the head of a user, when the user's head is moved closer to the antenna, communication performance may be significantly deteriorated. However, in the antenna 1, since each of the radiation electrode 8, the radiation electrode 10, and the radiation electrode 13 is loaded with a dielectric substance, for example, leakage of an electric field from the side 2a of the ground electrode 2 to the head of the user is prevented and minimized due to the dielectric base members 7 and 12.

In addition, since the radiation electrode 13 is connected at the central location 2b of the side 2a of the ground electrode 2, induced currents Ia and Ib flow in opposite directions from each other along the side 2a, as shown in FIG. 3. Thus, the induced currents Ia and Ib cancel each other. Therefore, when the user brings his or her head closer to the antenna, an electric field that leaks out from the four peripheral sides of the ground electrode 2 to the head can be reduced or prevented.

In addition, since the second non-feeding radiation element 5 is loaded with a dielectric substance due to the dielectric base member 12, the external planar dimensions of the second non-feeding radiation element 5 are reduced. Thus, even if the second non-feeding radiation element 5 projects outside the ground electrode 2, the size of the projection is reduced. In the antenna 1 according to this preferred embodiment, the external shape of the second non-feeding radiation element 5 is substantially flat and elongated, and the size of the projection is about 5 mm or less, for example. As a result, miniaturization of the entire antenna 1 is achieved.

In addition, the second non-feeding radiation element 5 is disposed such that the length in the longitudinal direction of the second non-feeding radiation element 5 falls within the length of the side 2a of the ground electrode 2, and a multiple resonance is produced. Thus, a ground wire, an antenna element, and other elements used in known technologies are not required at a corner of a ground plate (ground electrode 2). Therefore, in the antenna 1 according to this preferred embodiment, the shape of the four corner portions of the ground electrode 2 is not restricted due to the installation of the ground wire, and the flexibility in designing the entire shape and the flexibility in designing for mounting when a CCD image pickup element (not shown) or other pickup element is provided on the substrate 6 are improved.

As described above, in the antenna 1 according to this preferred embodiment, a reduction in the thickness and miniaturization of the overall size are achieved and a further increase in bandwidth is achieved.

### Preferred Embodiment 2

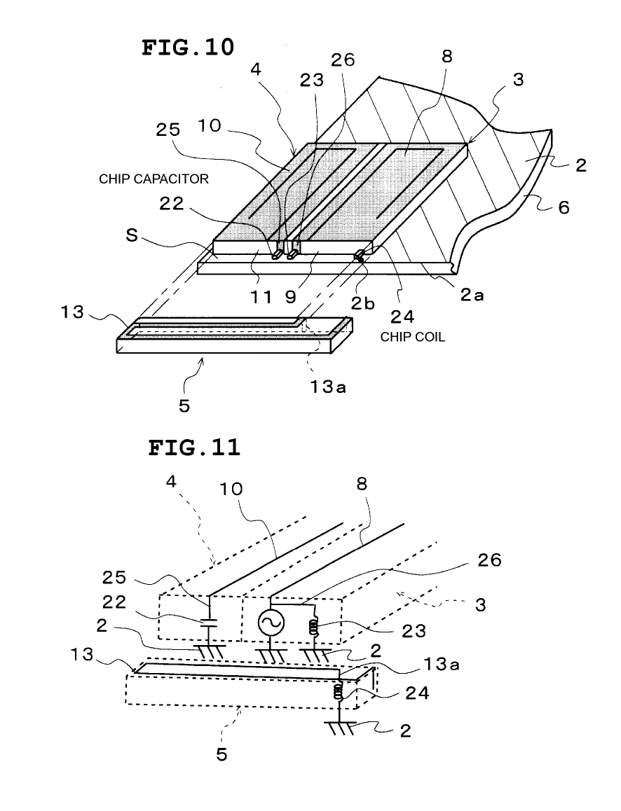

FIG. 10 is a perspective view of an antenna according to a second preferred embodiment of the present invention, and FIG. 11 is an equivalent circuit diagram showing the electric circuit structure of the antenna according to the second preferred embodiment. In the second preferred embodiment, the same components as in the first preferred embodiment are referred to with the same reference numerals.

In the antenna according to this preferred embodiment, the feeding radiation element 3 and the first non-feeding radiation element 4 are disposed on the ground electrode 2 such that the connection sides 9 and 11 are offset so as to be disposed slightly inward from the side 2a of the ground electrode 2, as shown in FIG. 10. A chip capacitor 22 and chip coils (chip inductors) 23 and 24 are provided in a space S on the ground electrode 2 generated by the offset.

The chip capacitor 22 is inserted between a connection wire 25 connected to the radiation electrode 10 and the ground electrode 2. The chip coil 23 is inserted between a connection wire 26 connected to the radiation electrode 8 and the ground electrode 2. The chip coil 24 is inserted between the end 13a of the radiation electrode 13 and the ground electrode 2. Thus, the antenna 21 according to this preferred embodiment has the structure shown in FIG. 11, in terms of an equivalent circuit.

That is, since the chip coil 23 is connected to the radiation electrode 8, the radiation electrode 8 is capable of achieving a desired matching for resonance characteristics due to the inductance of the chip coil 23. In addition, since the chip capacitor 22 is connected to the radiation electrode 10 and since the chip coil 24 is connected to the radiation electrode 13, a desired matching is achieved for respective resonance characteristics.

With the arrangement according to this preferred embodiment, desired resonance characteristics for the feeding radiation element 3, the first non-feeding radiation element 4, and the second non-feeding radiation element 5 are achieved easily and accurately by changing the characteristics of the chip capacitor 22, the chip coil 23, and the chip coil 24 without changing the shape and dimensions of the radiation electrode 8, the radiation electrode 10, and the radiation electrode 13, and without changing the material of the dielectric base members 7 and 12.

Since the other structural features, operations, and advantages are similar to those in the first preferred embodiment, descriptions thereof are omitted here.

### Preferred Embodiment 3

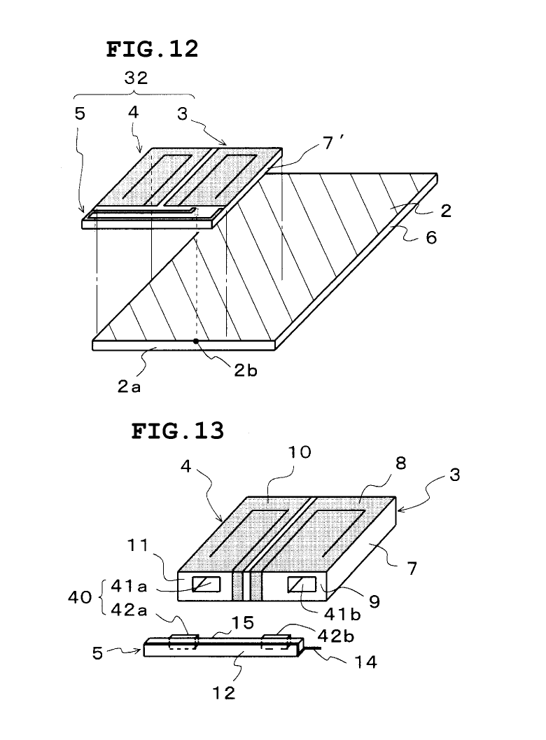

FIG. 12 is a perspective view of an antenna according to a third preferred embodiment of the present invention. In the third preferred embodiment, the same components as in the first preferred embodiment are referred to with the same reference numerals.

In the antenna according to this preferred embodiment, the feeding radiation element 3, the first non-feeding radiation element 4, and the second non-feeding radiation element 5 are integrated together to define a single surface-mount antenna element 32, as shown in FIG. 12.

That is, the surface-mount antenna element 32 includes the feeding radiation element 3, the first non-feeding radiation element 4, and the second non-feeding radiation element 5 disposed on a single dielectric base member 7′.

The surface-mount antenna element 32 is provided on the substrate 6 such that substantially the entire second non-feeding radiation element 5 projects from the side 2a and such that the feeding radiation element 3 and the first non-feeding radiation element 4 are disposed on the ground electrode 2.

As described above, since the feeding radiation element 3, the first non-feeding radiation element 4, and the second non-feeding radiation element 5 are integrated together as the surface-mount antenna element 32, mounting on the substrate 6 (the ground electrode 2) is easily performed.

Since the other structural features, operations, and advantages are similar to those in the first preferred embodiment, the descriptions thereof are omitted here.

### Preferred Embodiment 4

FIG. 13 is a perspective view showing a fitting structure of an antenna according to a fourth preferred embodiment of the present invention. In the fourth preferred embodiment, the same components as in the first preferred embodiment are referred to with the same reference numerals.

As shown in FIG. 13, in this preferred embodiment, fitting recesses 41a and 41b are provided in the feeding radiation element 3 and the first non-feeding radiation element 4, and fitting protrusions 42a and 42b are provided on the second non-feeding radiation element 5. That is, a fitting structure 40 includes the fitting recesses 41a and 41b and the fitting protrusions 42a and 42b.

More specifically, the fitting recesses 41a and 41b are provided in the connection sides 9 and 11 of the dielectric base member 7, and the fitting protrusions 42a and 42b are provided on the connection side 15 of the second non-feeding radiation element 5. Thus, by fitting the fitting protrusions 42a and 42b into the fitting recesses 41a and 41b, the second non-feeding radiation element 5 is connected at desired locations of the feeding radiation element 3 and the first non-feeding radiation element 4 in desired arrangement.

Here, it is preferable that the fitting shape of the fitting recess 41a and the fitting protrusion 42a be different from the fitting shape of the fitting recess 41b and the fitting protrusion 42b. Thus, each of a connection state between the second non-feeding radiation element 5 and the feeding radiation element 3 and a connection state between the second non-feeding radiation element 5 and the first non-feeding radiation element 4 is unique. Thus, for example, since the fitting recess 41a does not fit the fitting protrusion 42b, a situation in which the second non-feeding radiation element 5 is connected such that left and right are reversed is avoided.

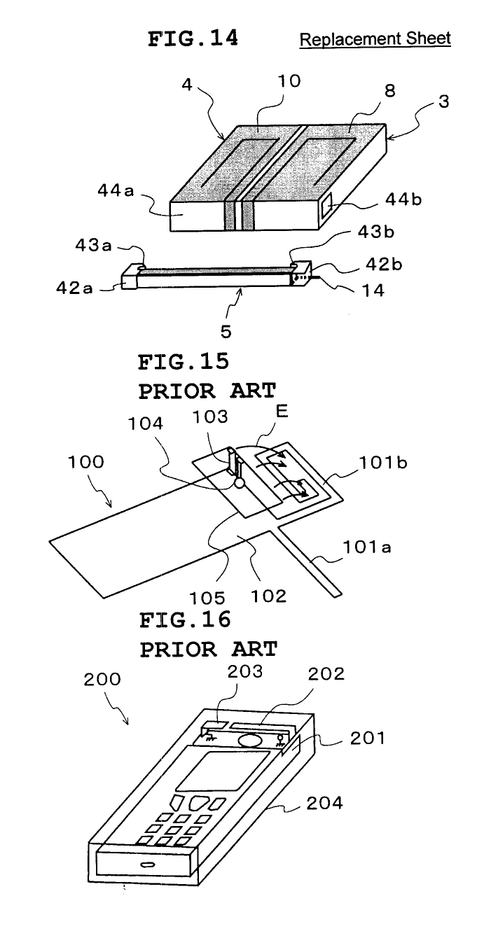

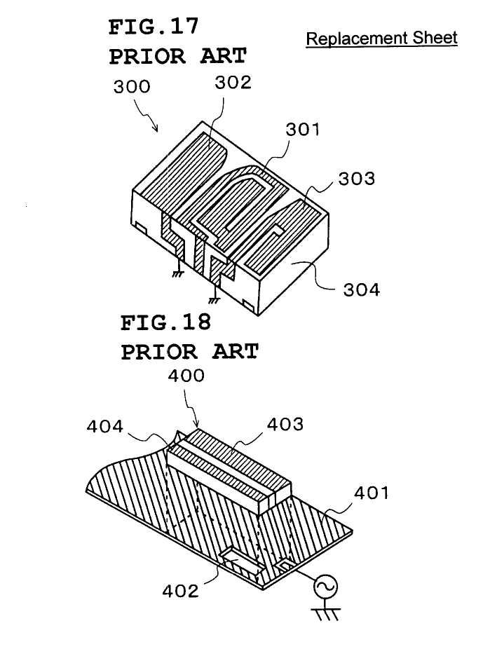

In addition, another fitting structure is possible, as shown in FIG. 14. That is, the fitting structure may include the fitting protrusions 42a and 42b including stop clicks 43a and 43b and fitting recesses 44a and 44b that are engaged with the stop clicks 43a and 43b.

Since the other structural features, operations, and advantages are similar to those in the first preferred embodiment, the descriptions thereof are omitted here.

The antenna according to each of the foregoing preferred embodiments is suitably usable as an antenna included in, for example, a portable radio communication apparatus, such as a cellular phone unit, for which a reduction in the thickness and miniaturization are required and for which a further increase in bandwidth is required.

The present invention is not limited to each of the foregoing preferred embodiments, and various changes and modifications can be made to the present invention without departing from the scope and spirit of the present invention.

For example, in each of the foregoing preferred embodiments, the radiation electrodes 8, 10, and 13 of the feeding radiation element 3 and the first and second non-feeding radiation elements 4 and 5 are disposed on the surface of the dielectric base members 7 and 12. However, the radiation electrodes 8, 10, and 13 may be disposed inside (within) the dielectric base members 7 and 12 such that the radiation electrodes 8, 10, and 13 are substantially parallel to the ground electrode 2.

In addition, in each of the foregoing preferred embodiments, the external shape of each of the feeding radiation element 3 and the first and second non-feeding radiation elements 4 and 5 is a substantially rectangular parallelepiped. However, the external shape is not limited to this. Any shape may be used as long as the external shape is three dimensional, such as a polygonal prism or a substantially circular cylinder.

In addition, in each of the foregoing preferred embodiments, a feeding element directly supplies power to the radiation electrode 8. However, a feeding element that is capable of supplying power to the radiation electrode 8 without contact by electromagnetic coupling may be used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-12. (canceled)

13. An antenna comprising:
a substrate including a ground electrode;
a feeding radiation element including a feeding element and a radiation electrode disposed inside or outside a dielectric substance;
a first non-feeding radiation element electrically connected to the ground electrode and including a radiation electrode disposed inside or outside the dielectric substance; and
a second non-feeding radiation element electrically connected to the ground electrode and including a radiation electrode disposed inside or outside the dielectric substance; wherein
the feeding radiation element is disposed on the ground electrode such that a surface of the radiation electrode of the feeding radiation element is substantially parallel to a surface of the ground electrode and such that the feeding radiation element is disposed in the vicinity of a desired side of four peripheral sides of the ground electrode;
the first non-feeding radiation element is disposed on the ground electrode such that a surface of the radiation electrode is substantially parallel to the surface of the ground electrode and such that the first non-feeding radiation element is disposed next to the feeding radiation element so as to be in the vicinity of the desired side of the ground electrode; and
the second non-feeding radiation element is disposed such that the second non-feeding radiation element is adjacent to both the feeding radiation element and the first non-feeding radiation element and such that at least a portion of the second non-feeding radiation element projects outside the ground electrode from the desired side of the ground electrode.

14. The antenna according to claim 13, wherein the dielectric substance is defined by a single base member.

15. The antenna according to claim 13, wherein the dielectric substance is defined by at least two separate dielectric base members.

16. The antenna according to claim 13, wherein the second non-feeding radiation element is electrically connected at a substantially central location of the desired side of the ground electrode.

17. The antenna according to claim 13, wherein a resonance produced by the second non-feeding radiation element is set to one of a higher frequency side and a lower frequency side of a multiple resonance produced by the feeding radiation element and the first non-feeding radiation element so as to produce a triple resonance.

18. The antenna according to claim 13, wherein a resonance produced by the second non-feeding radiation element is set to one of a higher frequency side and a lower frequency side of a multiple resonance produced by a harmonic wave of the feeding radiation element and a harmonic wave of the first non-feeding radiation element to produce a triple resonance.

19. The antenna according to claim 13, wherein:
the ground electrode is defined by a conductor pattern that is provided on the substrate and that has a substantially rectangular shape when viewed in plan;
the feeding radiation element and the first non-feeding radiation element are disposed in close proximity to one of two shorter sides at ends in a longitudinal direction of the ground electrode; and
the second non-feeding radiation element is arranged such that substantially the entire second non-feeding radiation element projects outside the ground electrode from the one of the two shorter sides.

20. The antenna according to claim 13, wherein the dielectric substance is defined by a dielectric base member, and the radiation electrode of each of the feeding radiation element, the first non-feeding radiation element, and the second non-feeding radiation element is provided on the dielectric base member or within the dielectric base member.

21. The antenna according to claim 20, wherein the feeding radiation element, the first non-feeding radiation element, and the second non-feeding radiation element are insert molded or outsert molded in the dielectric base member made of a dielectric material including thermoplastic resin.

22. The antenna according to claim 13, wherein the dielectric substance is defined by at least a first dielectric base member and a second dielectric base member, and the radiation electrode of each of the feeding radiation element and the first non-feeding radiation element is provided on a first dielectric base member, and the radiation electrode of the second non-feeding radiation element is provided on a second dielectric base member that is different from the first dielectric base member on which the radiation electrode of each of the feeding radiation element and the first non-feeding radiation element is provided.

23. The antenna according to claim 22, wherein:
the feeding radiation element and the first non-feeding radiation element are insert molded or outsert molded in the first dielectric base member made of a dielectric material and a thermoplastic resin; and
the second non-feeding radiation element is insert molded or outsert molded in the second dielectric base member made of a dielectric material and a thermoplastic resin.

24. The antenna according to claim 22, wherein the first dielectric base member and the second dielectric base member include a fitting structure in which a fitting state is uniquely defined by fitting the first dielectric base member to the second dielectric base member.

25. The antenna according to claim 23, wherein the first dielectric base member and the second dielectric base member include a fitting structure in which a fitting state is uniquely defined by fitting the first dielectric base member to the second dielectric base member.

26. The antenna according to claim 13, wherein at least one of a chip capacitor and a chip inductor is provided in a middle portion of at least one of an electrical connection path between the radiation electrode of the feeding radiation element and the ground electrode, an electrical connection path between the radiation electrode of the first non-feeding radiation element and the ground electrode, and an electrical connection path between the radiation electrode of the second non-feeding radiation element and the ground electrode.

27. A portable radio communication apparatus comprising the antenna as set forth in claim 13.
